(19) United States
(12) Patent Application Publication
(10) Pub. No.: US 2026/0154595 A1
(43) Pub. Date: Jun. 4, 2026

(54) LEARNING AND LEVERAGING QUANTUM NOISE FOR MACHINE LEARNING

(71) Applicant: International Business Machines Corporation, Armonk, NY (US)

(72) Inventors: Takahiro Yamamoto, Bunkyo-ku (JP); Hwajung Kang, Yorktown Heights, NY (US); Brian Leo Quanz, Yorktown Heights, NY (US); Jae-Eun Park, Wappingers Falls, NY (US); Ginés Carrascal de las Heras, Getafe (ES); Edgar Andres Ruiz Guzman, Orsay (FR); Das Pemmaraju, Stockton, CA (US)

(21) Appl. No.: 19/044,187

(22) Filed: Feb. 3, 2025

(30) Foreign Application Priority Data
Dec. 3, 2024 (EP) 24383314.2

(51) Int. Cl. G06N 10/60; G06N 10/70

(52) U.S. Cl. CPC G06N 10/60; G06N 10/70

(57) ABSTRACT

One or more systems, devices, computer program products and/or computer-implemented methods of use provided herein relate to learning and leveraging quantum hardware noise for quantum machine learning (QML). For example, according to an embodiment, a system is provided. The system can comprise a memory that can store computer-executable components. The system can further comprise a processor that can execute the computer-executable components stored in the memory, where the computer-executable components can comprise a noise learning component that can learn, based on an ansatz circuit and an input dataset, quantum hardware noise. The computer-executable components can further comprise a QML component that can employ the quantum hardware noise in an adaptive QML process.

### BACKGROUND

The subject disclosure relates to quantum machine learning (QML) and, more specifically, to learning and leveraging quantum hardware noise for QML.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable learning and leveraging quantum hardware noise for QML are discussed.

According to an embodiment, a system is provided. The system can comprise a memory that can store computer-executable components. The system can further comprise a processor that can execute the computer-executable components stored in the memory, where the computer-executable components can comprise a noise learning component that can learn, based on an ansatz circuit and an input dataset, quantum hardware noise. The computer-executable components can further comprise a quantum machine learning (QML) component that can employ the quantum hardware noise in an adaptive QML process.

According to another embodiment, a system is provided. The system can comprise a memory that can store computer-executable components. The system can further comprise a processor that can execute the computer-executable components stored in the memory, where the computer-executable components can comprise a data access component that can access an ansatz circuit and an input dataset. The computer-executable components can further comprise a noise learning component that can learn, based on the ansatz circuit and the input dataset, quantum hardware noise associated with a quantum hardware by executing the ansatz circuit on the quantum hardware, where the quantum hardware noise can be employable in an adaptive QML process.

According to various embodiments, the above-described systems can be implemented as computer-implemented methods or as computer program products.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a block diagram of an example, non-limiting system that can learn quantum hardware noise and employ the quantum hardware noise in QML, in accordance with one or more embodiments described herein.

FIG. 2 illustrates another block diagram of an example, non-limiting system that can learn quantum hardware noise and employ the quantum hardware noise in QML, in accordance with one or more embodiments described herein.

FIG. 3 illustrates diagrams of example, non-limiting graphs showing quantum hardware noise effects and an example, non-limiting table showing meta model results based on the quantum hardware noise effects, in accordance with one or more embodiments described herein.

FIG. 4 illustrates a flow diagram of an example, non-limiting method that can learn quantum hardware noise and employ the quantum hardware noise in QML, in accordance with one or more embodiments described herein.

FIG. 5 illustrates diagrams of example, non-limiting quantum circuits that can be generated and utilized as part of the non-limiting method of FIG. 4, in accordance with one or more embodiments described herein.

FIG. 6 illustrates diagrams of an example, non-limiting method and an example, non-limiting ensemble that can be employed as part of the non-limiting method of FIG. 4, in accordance with one or more embodiments described herein.

FIG. 7 illustrates diagrams of example, non-limiting graphs showing results of optimizing noise model coefficients, in accordance with one or more embodiments described herein.

FIGS. 8-10 illustrates diagrams of example, non-limiting graphs showing quantum hardware noise effects for different qubits and different quantum operators, in accordance with one or more embodiments described herein.

FIG. 11 illustrates flow diagram of example, non-limiting methods that can learn quantum hardware noise and employ the quantum hardware noise in QML, in accordance with one or more embodiments described herein.

FIG. 12 illustrates a flow diagram of an example, non-limiting method that can optimize a noise model representative of quantum hardware noise, in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer-executable components. The system can further comprise a processor that can execute the computer-executable components stored in the memory, where the computer-executable components can comprise a noise learning component that can learn, based on an ansatz circuit and an input dataset, quantum hardware noise. The computer-executable components can further comprise a QML component that can employ the quantum hardware noise in an adaptive QML process.

Such embodiments of the system can provide a number of advantages, including employing quantum hardware noise for more efficient quantum computing and increasing the accuracy of outcomes generated via QML modeling.

In one or more embodiments of the aforementioned system, learning the quantum hardware noise can comprise executing, by a quantum circuit execution component, the ansatz circuit via a noiseless simulation, where the executing the ansatz circuit via the noiseless simulation can generate a first noise profile. The learning the quantum hardware noise can further comprise executing, by the quantum circuit execution component, the ansatz circuit on a quantum hardware, where the executing the ansatz circuit on the quantum hardware can generate a second noise profile.

Such embodiments of the system can provide the advantage of observing the differences in quantum hardware noise effects generated via a simulation and a quantum hardware.

In one or more embodiments of the aforementioned system, the learning the quantum hardware noise can further comprise learning, by the noise learning component, a noise model that can capture differences between the first noise profile and the second noise profile. The learning the quantum hardware noise can further comprise identifying, by the noise learning component, based on the noise model, first modifications applicable to the ansatz circuit to reproduce the second noise profile.

Such embodiments of the system can provide a number of advantages, including capturing the quantum hardware noise specific to the quantum hardware and identifying quantum operations that can be applied to the ansatz circuit to incorporate the quantum hardware noise in the ansatz circuit.

In one or more embodiments of the aforementioned system, a quantum circuit generation component can apply the first modifications to the ansatz circuit, where applying the first modifications can generate a quantum circuit that is employable to transform the input dataset into a transformed dataset.

Such embodiments of the system can provide the advantage of incorporating the quantum hardware noise effects associated with the quantum hardware in the ansatz circuit, as a result of which, the quantum circuit resulting from the modification can reflect the quantum hardware noise.

In one or more embodiments of the aforementioned system, the QML component can employ the transformed dataset in the adaptive QML process, where the adaptive QML process can be based on a QML model or an ensemble comprising QML models and classical machine learning models.

Such embodiments of the system can provide a number of advantages, including increasing accuracies of outcomes generated by QML models and increasing diversity in ensembles.

In one or more embodiments of the aforementioned system, a noise adjustment component can adjust the second noise profile by adjusting the first modifications according to the adaptive QML process.

Such embodiments of the system can provide the advantage of controlling the quantum hardware noise effects associated with the quantum hardware according to different applications.

In one or more embodiments of the aforementioned system, the noise adjustment component can further adjust a third noise profile resulting from drift in the quantum hardware or execution of the ansatz circuit on a new quantum hardware, where the adjusting the third noise profile can comprise adjusting second modifications applicable to the ansatz circuit to reproduce the third noise profile.

Such embodiments of the system can provide the advantage of reproducing the quantum hardware noise for different quantum hardware configurations, on different quantum hardware, and in case of quantum hardware drift.

In one or more embodiments of the aforementioned system, an optimization component can optimize the quantum hardware noise by optimizing coefficients of the noise model, where the optimizing the coefficients can comprise measuring, by the optimization component, a set of observable measurements on the quantum hardware. The optimizing the coefficients can further comprise generating, by the optimization component, simulated observable measurements for the noise model, where the simulated observable measurements can be generated with or without perturbed coefficients. The optimizing the coefficients can further comprise calculating, by the optimization component, a difference between the set of observable measurements and the simulated observable measurements, where the difference can be measured for respective parameters. The optimizing the coefficients can further comprise updating, by the optimization component, the coefficients of the noise model to reduce an error between the set of observable measurements and the simulated observable measurements until the error converges.

Such embodiments of the system can provide the advantage of generating the most suitable noise model for a particular quantum hardware and an input dataset.

According to another embodiment, a system is provided. The system can comprise a memory that can store computer-executable components. The system can further comprise a processor that can execute the computer-executable components stored in the memory, where the computer-executable components can comprise a data access component that can access an ansatz circuit and an input dataset. The computer-executable components can further comprise a noise learning component that can learn, based on the ansatz circuit and the input dataset, quantum hardware noise associated with a quantum hardware by executing the ansatz circuit on the quantum hardware, where the quantum hardware noise can be employable in an adaptive QML process.

Such embodiments of the system can provide a number of advantages, including employing quantum hardware noise for more efficient quantum computing and increasing the accuracy of outcomes generated via QML modeling.

In one or more embodiments of the aforementioned system, learning the quantum hardware noise can comprise partitioning, by a circuit partitioning component, the ansatz circuit into a set of smaller circuits. The learning the quantum hardware noise can further comprise learning, by the noise learning component, respective noise models for respective smaller circuits comprised in the set of smaller circuits. The learning the quantum hardware noise can further comprise combining, by the noise learning component, the respective noise models to learn a noise model corresponding to the ansatz circuit.

Such embodiments of the system can provide the advantage of effectively learning quantum hardware noise given ansatz circuits that are too large to be simulated.

According to various embodiments, the above-described systems can be implemented as computer-implemented methods or as computer program products.

According to another embodiment, a computer-implemented method is provided. The computer-implemented method can comprise accessing, by a system operatively coupled to a processor, an ansatz circuit and an input dataset. The computer-implemented method can further comprise learning, by the system, based on the ansatz circuit and the input dataset, quantum hardware noise associated with a quantum hardware by executing the ansatz circuit on the quantum hardware, where the quantum hardware noise can be employable in an adaptive QML process.

Such embodiments of the system can provide a number of advantages, including employing quantum hardware noise for more efficient quantum computing and increasing the accuracy of outcomes generated via QML modeling.

In one or more embodiments of the aforementioned computer-implemented method, the learning can comprise identifying, by the system, a noise model that can eliminate hardware noise effects associated with the quantum hardware.

Such embodiments of the computer-implemented method can provide the advantage of effectively learning quantum hardware noise given ansatz circuits that are too large to be simulated.

In one or more embodiments of the aforementioned computer-implemented method, the learning can comprise learning, by the system, a delta noise model by comparing first results of a first quantum computation and second results of a second quantum computation, where the first quantum computation can involve error mitigation, and where the second quantum computation can be performed without the error mitigation.

Such embodiments of the computer-implemented method can provide the advantage of effectively learning quantum hardware noise given ansatz circuits that are too large to be simulated.

According to various embodiments, the above-described computer-implemented method can be implemented as a system or as a computer program product.

An embodiment in which the noise learning component can learn, based on the ansatz circuit and the input dataset, the quantum hardware noise, and the optimization component can optimize the corresponding noise model has the advantage of further increasing the accuracy of outcomes generated via QML modeling by employing the most suitable noise model in the QML modeling, given a particular quantum hardware and the input dataset.

An embodiment in which learning the quantum hardware noise can comprise partitioning, by a circuit partitioning component, the ansatz circuit into a set of smaller circuits and learning, by the noise learning component, respective noise models for respective smaller circuits comprised in the set of smaller circuits can have the advantage of effectively employing quantum hardware noise learning to improve the outcomes of QML modeling even in scenarios where the ansatz circuit is of a large size and therefore, challenging to simulate.

An embodiment in which learning the quantum hardware noise can comprise identifying, by the system, a noise model that can eliminate hardware noise effects associated with the quantum hardware can have the advantage of effectively employing quantum hardware noise learning to improve the outcomes of QML modeling even in scenarios where the ansatz circuit is of a large size and therefore, challenging to simulate.

An embodiment in which learning the quantum hardware noise can comprise learning, by the system, a delta noise model by comparing first results of a first quantum computation and second results of a second quantum computation, where the first quantum computation can involve error mitigation, and where the second quantum computation can be performed without the error mitigation can have the advantage of effectively employing quantum hardware noise learning to improve the outcomes of QML modeling even in scenarios where the ansatz circuit is of a large size and therefore, challenging to simulate.

The various embodiments disclosed herein can be employed in different use cases. For example, in one or more embodiments, the above-described systems can be employed to identify effective ways of applying QML modeling to practical classical datasets across many domains, and to acquire benefits beyond classical machine learning modeling by employing quantum hardware noise, thereby greatly increasing the applicability of QML and the corresponding benefits. This can be advantageous for many end entity (e.g., hardware, software, machine, AI, neural network and/or user) use cases that primarily comprise and employ classical machine learning datasets.

According to various embodiments, the above-described systems can be implemented as computer-implemented methods or as computer program products.

### Definitions

Machine learning model: A machine learning model can be described as a parameterized function that can map a data point (i.e., an input) to a target prediction (i.e., an output). For example, a machine learning model can be a neural network that can ingest a vector representing an image (i.e., an input) and output the probability of the image being in each class comprised in a set of classes (i.e., an output).

QML: QML is a machine learning approach that employs a machine learning model and/or algorithm and that incorporates quantum computing. For example, in the various embodiments of the present disclosure, a quantum circuit can be employed as part of a machine learning model to map an input to final output predictions.

Meta model/ensemble: A meta model or ensemble is a machine learning model that can take as inputs, predictions of other machine learning models (referred to herein as base models) and output a new prediction for a target by combining the inputs from different machine learning models in a suitable manner for each prediction output.

Diversity: With reference to a set of machine learning models, diversity refers to different predictions generated across data inputs from a dataset by individual machine learning models comprised in a set of machine learning models. That is, greater variance in predictions generated by the set of machine learning models, or less correlation in the predictions generated by the set of machine learning models, corresponds to greater diversity. Diversity is a key property for ensembles to improve accuracy. The diversity of a set of base models is based on Van Den Berg et al. (Van Den Berg et al. Probabilistic error cancellation with sparse Pauli-Lindblad models on noisy quantum processors. Nature physics 19.8 (2023): 1116-1121).

Pauli noise channel: A Pauli noise channel or Pauli error channel is a class of theoretical quantum error channels in which errors are described by a set of tensor products of Pauli operators and Pauli error rates.

Quantum noise refers to fluctuations or disturbances in a quantum system that can adversely affect the qubits in the quantum system, thereby compromising the accuracy of quantum computations based on the quantum system. For example, quantum noise can introduce errors in calculations and reduce the reliability of quantum algorithms. To address quantum noise, existing quantum computing techniques typically aim to reduce the negative effects of quantum noise via techniques such as error mitigation, error correction, etc. For example, an existing technique in the art involves quantum reservoir computing for time series modeling. This approach attempts to access the quantum noise inherent in quantum systems, or in case of noiseless systems, to create the noise via a noise model, and employ the quantum noise or noise models to create random temporal dynamics and temporal effects (such as damping over time) that are specifically beneficial for time series modeling. For example, the temporal dynamics and temporal effects can be employed as basis functions to fit a time series model as a linear combination of the basis functions. Another existing technique involves machine learning to make quantum circuits robust to quantum noise or to mitigate quantum noise. Yet another existing (one-off) technique involves finding a specialized hypothetical (non-practical) problem where the benefit of quantum computing over classical computing is robust to quantum hardware noise. Thus, existing quantum computing techniques typically aim to mitigate quantum noise or reduce the effects of quantum noise on quantum computations as opposed to beneficially employing quantum hardware.

The inventors of the subject application realized that quantum hardware noise can be learnt and beneficially employed in QML. Accordingly, embodiments described herein include systems, computer-implemented methods, and computer program products that can learn and beneficially incorporate quantum hardware noise for QML modeling. For example, the various embodiments disclosure herein can employ quantum hardware noise as a resource by controlling the effects of the quantum hardware noise (i.e., quantum hardware noise effects) to generate desirable outcomes from QML modeling. For example, in one or more embodiments, a quantum hardware noise leveraging model is provided that can learn and control quantum hardware noise and unique quantum hardware noise effects and effectively incorporate the quantum hardware noise in QML approaches. As a result, the quantum hardware noise effects can be consistently reproduced within different quantum hardware (including quantum hardware of the future with improved error mitigation), with different quantum hardware configurations and in the presence of quantum hardware drift, which refers to the phenomena where the characteristics of quantum hardware noise on a quantum hardware can change over time.

More specifically, in one or more embodiments, given an input dataset, the quantum hardware noise leveraging model can execute an ansatz circuit via a simulation (e.g., on a classical simulator of a quantum computer), wherein the simulation can generate a first noise profile, and the quantum hardware noise leveraging component can execute the ansatz circuit on a quantum hardware, wherein execution of the ansatz circuit on the quantum hardware can generate a second noise profile. In one or more embodiments, based on the first noise profile and the second noise profile, the quantum hardware noise leveraging component can learn a noise model representing the noise present in the quantum hardware (i.e., quantum hardware noise). In one or more embodiments, the quantum hardware noise leveraging model can optimize the noise model by optimizing coefficients of the noise model. Further, in one or more embodiments, the quantum hardware noise leveraging model can identify and apply, based on the noise model, first modifications to the ansatz circuit, wherein applying the first modifications can generate a quantum circuit that can be executable on a simulator, a different quantum hardware, etc. to reproduce the second noise profile. The first modifications can comprise quantum gates and operations, and the quantum circuit can be employable to transform the input dataset into a transformed dataset. For example, in one or more embodiments, quantum hardware noise leveraging model can execute the quantum circuit on a quantum hardware as a result of which, the quantum circuit can encode data comprised in the input dataset into qubits and apply quantum operations to generate the transformed dataset. In one or more embodiments, the quantum hardware noise leveraging model can employ the transformed dataset in an adaptive QML process to train one or more QML models. In one or more embodiments, training the one or more QML models can create diversity within the models, and quantum hardware noise leveraging model can employ the trained QML models to generate an ensemble comprising the one or more QML models and one or more classical machine learning models.

In one or more embodiments, quantum hardware noise leveraging model can also learn quantum hardware noise without simulating the ansatz circuit if the ansatz circuit is a large sized circuit that can be challenging to simulate. For example, in an embodiment, the quantum hardware noise leveraging model can partition an ansatz circuit into a set of smaller circuits, learn the respective noise models corresponding to respective smaller circuits comprised in the set of smaller circuits and combine the respective noise models to learn the quantum hardware noise. In another embodiment, the quantum hardware noise leveraging model can learn the noise model by identifying a model that can eliminate quantum hardware noise effects. In yet another embodiment, the quantum hardware noise leveraging model can learn the noise model by comparing the results of a quantum computation performed with heavier error mitigation with the results of a quantum computation performed without any error mitigation to learn a delta noise model.

Contrary to existing techniques that attempt to minimize quantum hardware noise to generate desirable results, the various embodiments described herein can adapt to quantum hardware noise by learning to account for the quantum hardware noise. For example, with reference to the existing techniques previously discussed, the technique of employing quantum reservoir computing for time series modeling employs quantum noise differently as compared to embodiments of the present disclosure. This technique does not involve the aspects of tuning quantum noise by learning a Pauli noise channel for a given ansatz family by executing an ansatz circuit on a quantum hardware, changing the Pauli noise channel to improve diversity, adjusting the ansatz circuit to better match input data and incorporating the ansatz circuit as part of a general QML pipeline. This technique also does not involve the aspect of adapting a noise model to changes in quantum hardware to match the noise with the quantum hardware. Similarly, although the existing technique of making quantum circuits robust to quantum noise employs machine learning to address the quantum noise, this technique aims to identify the best ways to remove the effects of quantum noise. On the contrary, embodiments of the present disclosure aim to beneficially leverage quantum noise (e.g., in QML pipelines) and learn a controllable noise model that can be employed to adjust the quantum noise/overall quantum system models as desired. Finally, the technique of finding a specialized hypothetical (non-practical) problem does not consider the type of problem to be solved, the general machine learning process and pipeline for practical (i.e., real-world) data, or other embodiments of the present disclosure.

The various embodiments described herein can be employed in QML modeling to generate desirable results without closely replicating the performance of a simulator, that is, a noiseless operation of a quantum hardware. Furthermore, the various embodiments herein can leverage the quantum hardware noise inherent in quantum hardware as a potential resource that can lead to better overall QML modeling results, in a programmatic and adaptive way, as compared to existing techniques. This aspect is unique to approaches for QML applied to regular tabular data. Additionally, contrary to existing techniques that can incorporate quantum noise in quantum computing techniques, the various embodiments described herein can also identify the most suitable quantum hardware noise based on an input dataset, and model and control/modify the quantum hardware noise. Thus, the various embodiments described herein can provide a noise learning and controlling approach comprising practical steps of learning a noise model. The various embodiments described herein can also provide different approaches to optimize noise model coefficients with quantum hardware, including approaches to optimize noise model coefficients for large scale quantum circuits.

The embodiments of the present disclosure represent new scientific discoveries in terms of beneficially employing quantum hardware noise. The embodiments of the present disclosure also represent major breakthroughs that can be employed to demonstrate the benefits of QML across an increased number of client use cases such as, for example, applying QML to real-world business problems, that can lead to many successful client projects and assist organizations with bringing in several client projects. Depending on the quantum hardware (e.g., quantum computer, quantum computing system/device, quantum machine, etc.), the various benefits of the embodiments of the present disclosure highlighted herein can be realized, and employing quantum hardware in real-world industry processes can become feasible. Additionally, the various embodiments described herein can be employed in existing quantum hardware and be applicable to quantum hardware of the future. The methods and techniques disclosed herein can remain relevant and applicable even as new quantum error-correction techniques are introduced. As such, the methods and techniques disclosed herein can be central to making QML effective with the introduction of improved error mitigation techniques.

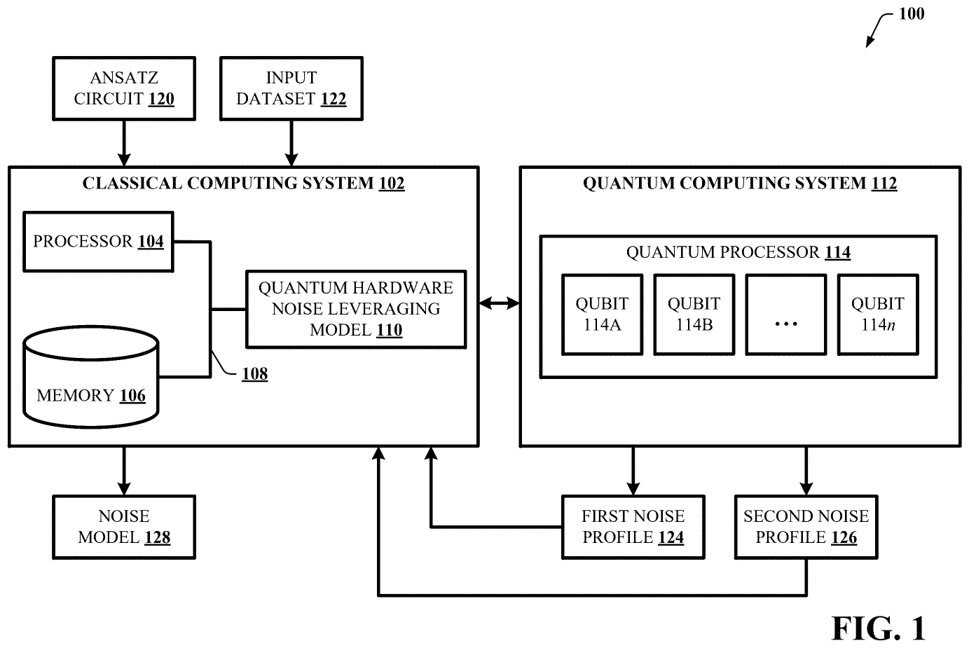

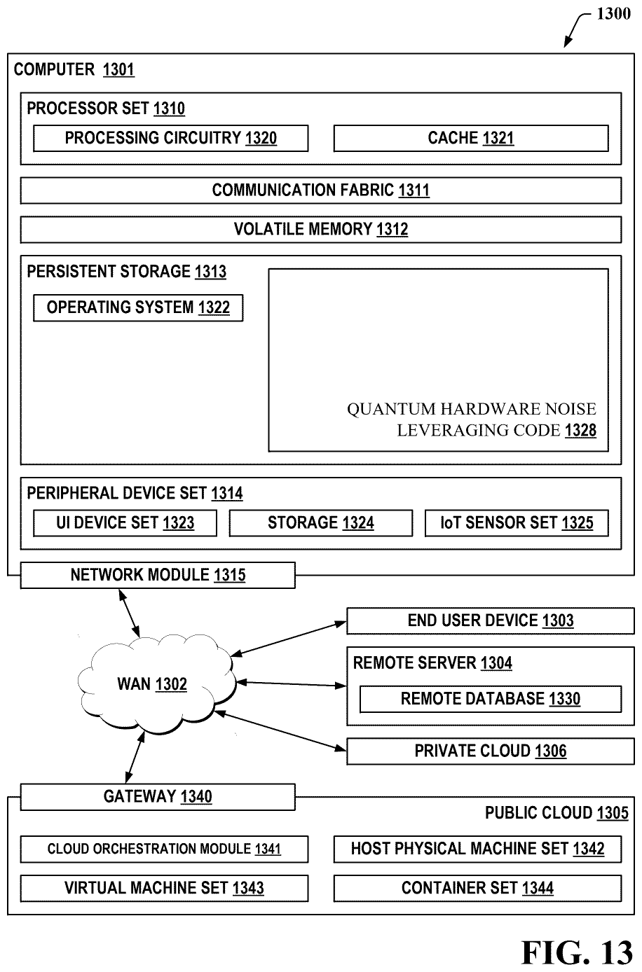

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, non-limiting system 100 can be associated with, such as accessible via, a computing environment 1300 described below with reference to FIG. 13, such that aspects of processing can be distributed between non-limiting system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can learn quantum hardware noise and employ the quantum hardware noise in QML, in accordance with one or more embodiments described herein.

Non-limiting system 100 and/or the components of non-limiting system 100 can be employed to use hardware and/or software to solve problems that are highly technical in nature (e.g., related to quantum hardware noise, QML modeling, employing quantum hardware noise in QML modeling, etc.), that are not abstract and that cannot be performed as a set of mental acts by a human. Further, some of the processes performed may be performed by specialized computers for carrying out defined tasks related to learning and leveraging quantum hardware noise for QML. Non-limiting system 100 and/or components of non-limiting system 100 can be employed to solve new problems that arise through advancements in technologies mentioned above, computer architecture, and/or the like. Non-limiting system 100 can provide improvements to quantum computing systems by beneficially employing quantum hardware noise to increase the accuracies of QML models and ensembles, achieving higher fidelities for quantum applications, etc.

As illustrated in FIG. 1, non-limiting system 100 can comprise classical computing system 102 and quantum computing system 112. Classical computing system 102 can be coupled (operatively, communicatively, electrically, and/or like function) to quantum computing system 112. Quantum computing system 112 can comprise at least one quantum processor, such as quantum processor 114. Classical computing system 102 can comprise one or more components, such as a memory 106, processor 104, bus 108, and/or quantum hardware noise leveraging model 110. In an embodiment, quantum hardware noise leveraging model 110 can be comprised at least partially by quantum computing system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit. In one or more embodiments, quantum computing system 112 can also be a classical simulator of a quantum computer.

Discussion turns briefly to processor 104, memory 106 and bus 108 of classical computing system 102. For example, in one or more embodiments, classical computing system 102 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, classical computing system 102 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., quantum hardware noise leveraging model 110, data access component 202, noise learning component 204, quantum machine learning (QML) component 206, quantum circuit execution component 208, quantum circuit generation component 210, noise adjustment component 212, optimization component 214 and/or circuit partitioning component 216) to perform one or more actions. In one or more embodiments, memory 106 can store computer-executable components (e.g., quantum hardware noise leveraging model 110, data access component 202, noise learning component 204, QML component 206, quantum circuit execution component 208, quantum circuit generation component 210, noise adjustment component 212, optimization component 214 and circuit partitioning component 216).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

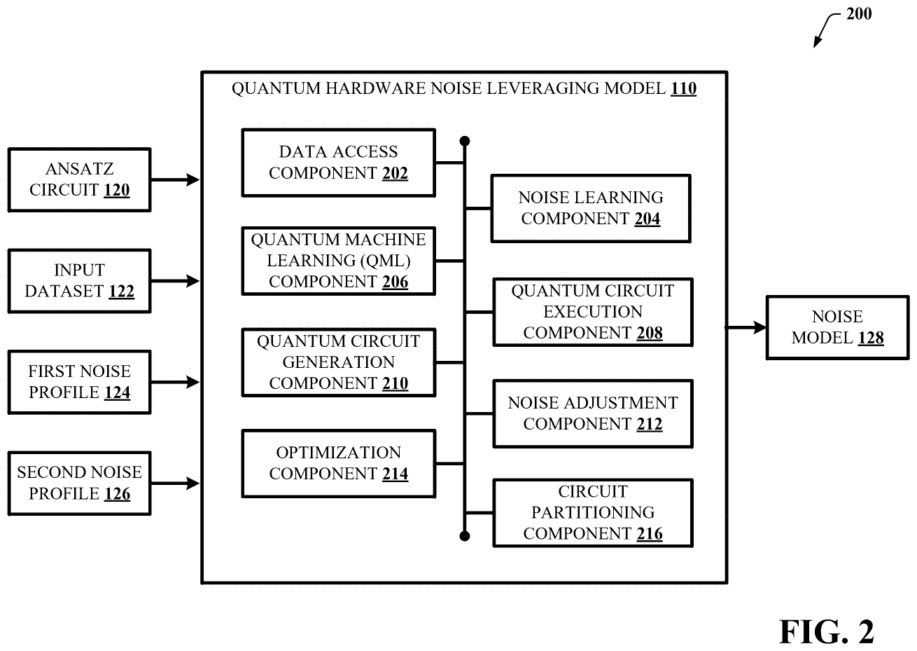

In one or more embodiments, quantum hardware noise leveraging model 110 can comprise data access component 202, noise learning component 204, QML component 206, quantum circuit execution component 208, quantum circuit generation component 210, noise adjustment component 212, optimization component 214 and circuit partitioning component 216, as illustrated in FIG. 2. In one or more embodiments, quantum hardware noise leveraging model 110 can learn quantum hardware noise and employ the quantum hardware noise for QML. For example, in various embodiments, data access component 202 can access ansatz circuit 120 and input dataset 122.

In one or more embodiments, noise learning component 204 of quantum hardware noise leveraging model 110 can learn, based on ansatz circuit 120 and input dataset 122, quantum hardware noise associated with a quantum hardware. For example, in one or more embodiments, quantum circuit execution component 208 can execute ansatz circuit 120 via a noiseless simulation on a simulator (e.g., a classical simulator of a quantum computer), wherein executing ansatz circuit 120 via the noiseless simulation can generate first noise profile 124. Quantum circuit execution component 208 can additionally execute ansatz circuit 120 on a quantum hardware, wherein executing ansatz circuit 120 on the quantum hardware can generate second noise profile 126. In one or more embodiments, noise learning component 204 can learn, based on first noise profile 124 and second noise profile 126, noise model 128, wherein noise model 128 can capture differences between first noise profile 124 and second noise profile 126. Based on noise model 128, noise learning component 204 can identify first modifications applicable to ansatz circuit 120 to reproduce second noise profile 126 (e.g., on a different quantum hardware). For example, the first modifications can comprise quantum gates and/or quantum operations that can be inserted into ansatz circuit 120 to incorporate quantum hardware noise effects into ansatz circuit 120.

In one or more embodiments, noise learning component 204 can learn noise model 128 by performing noise-aware quantum mapping. For example, by capturing the differences between first noise profile 124 and second noise profile 126, noise learning component 204 can create a quantum mapping between first noise profile 124 and second noise profile 126, wherein the quantum mapping can be employed by noise learning component 204 to learn noise model 128.

In one or more embodiments, the quantum circuit generated based on noise model 128 can be employed in QML modeling. For example, in one or more embodiments, QML component 206 can employ the quantum hardware noise in an adaptive QML process. For example, quantum circuit generation component 210 can apply the first modifications to ansatz circuit 120, wherein applying the first modifications to ansatz circuit 120 can generate a quantum circuit (also known as a blueprint or a blueprint circuit/blueprint quantum circuit) that can be employed to transform input dataset 122 into a transformed dataset. For example, the quantum circuit can be executed on a quantum hardware to transform input dataset 122 and generate the transformed dataset. Execution of the quantum circuit on the quantum hardware can reproduce second noise profile 126, since the first modifications applied to ansatz circuit 120 to generate the quantum circuit can be based on quantum hardware noise. Stated differently, inserting the first modifications into ansatz circuit 120 can transplant the quantum hardware noise effects corresponding to noise model 128 into ansatz circuit 120, thereby generating a quantum circuit that can be executed to reproduce second noise profile 126. In one or more embodiments, QML component 206 can employ the transformed dataset in an adaptive QML process that can be based on a QML model or an ensemble comprising one or more QML models and one or more classical machine learning models. For example, QML component 206 can employ the transformed dataset to train one or more machine learning models (e.g., an Extreme Gradient Boosting (XGBoost) model, a Random Forest (RF) model and/or another machine learning model) to identify complex patterns in input dataset 122.

In one or more embodiments, QML component 206 can also run/execute the quantum circuit on a simulator to model/train the machine learning models employed in the adaptive QML process. For example, QML component 206 can execute the quantum circuit on a smaller scale to perform initial tuning and configuration or training of a machine learning model prior to executing the quantum circuit on a quantum hardware to generate the transformed dataset.

In various embodiments, the quantum hardware noise can be adjusted prior to employing the quantum hardware noise in the adaptive QML process. For example, in one or more embodiments, noise adjustment component 212 can adjust second noise profile 126 by adjusting the first modifications (e.g., quantum gates and/or quantum operations) applied to ansatz circuit 120 according to the adaptive QML process. For example, once noise model 128 is learnt by noise learning component 204, noise adjustment component 212 can add specific quantum gates to ansatz circuit 120 to fine tune the quantum hardware noise represented by noise model 128 or to generate additional noise in a beneficial way. Such adjustments to second noise profile 126 can generate a degree of complexity in the data representation of input dataset 122 that can assist a machine learning model employed in the adaptive QML process to make better inferences based on the corresponding transformed dataset. Quantum hardware noise is complex and can be challenging to reproduce without quantum hardware. Thus, when there is no noise at the end of a quantum circuit, the quantum hardware noise can create inside quantum hardware, a more complex structure of quantum states that can introduce complexity for a machine learning model, wherein the complexity can assist the machine learning model to identify complex relations in data (e.g., input dataset 122).

Thus, in an embodiment, transforming transform input dataset 122 into a transformed dataset can comprise applying, by quantum circuit generation component 210, the first modifications to ansatz circuit 120 to generate a quantum circuit, whereas in another embodiment, transforming transform input dataset 122 into a transformed dataset can comprise applying, by quantum circuit generation component 210, the first modifications to ansatz circuit 120, and adding, by noise adjustment component 212, specific quantum gates to ansatz circuit 120. The resulting transformed dataset can be employed in an adaptive QML process involving a QML model or an ensemble comprising one or more QML models and one or more classical machine learning models to make predictions/inferences. Employing quantum hardware noise can augment the capacity of machine learning models (i.e., QML models and/or classical machine learning models) in detecting complex relationships in input dataset 122. That is, in various embodiments, quantum hardware noise can be extracted and employed to generate results that can be better (e.g., more accurate, etc.) than those generated without beneficially employing quantum hardware noise. In one or more embodiments, the QML modeling based on the quantum hardware noise or an evaluation of metrics subsequent to the QML modeling can also be employed (e.g., by quantum hardware noise leveraging model 110) to extract information from input dataset 122.

In one or more embodiments, noise adjustment component 212 can further adjust a third noise profile (not illustrated) resulting from drift in the quantum hardware (i.e., the quantum hardware employed to generate second noise profile 126) or from execution of ansatz circuit 120 on a new quantum hardware, wherein adjusting the third noise profile can comprise adjusting second modifications that can be applied to ansatz circuit 120 to reproduce the third noise profile. For example, in one or more embodiments, the quantum hardware employed to generate second noise profile 126 can experience drift or the quantum hardware can be replaced with a new quantum hardware. Execution of ansatz circuit 120 (e.g., by quantum circuit execution component 208) on the quantum hardware with drift or on the new quantum hardware can generate a third noise profile that can be different from first noise profile 124 and second noise profile 126. In one or more embodiments, noise learning component 204 can learn a noise model that can capture differences between first noise profile 124 and the third noise profile. Based on the noise model, noise learning component 204 can identify second modifications applicable to ansatz circuit 120 to reproduce the third noise profile (e.g., on a different quantum hardware). In one or more embodiments, noise adjustment component 212 can adjust the second modifications to generate second noise profile 126.

Thus, in one or more embodiments, noise learning component 204 can find the modifications (e.g., first modifications) that can be applied to an ideal circuit (e.g., ansatz circuit 120) and that can match a particular quantum hardware noise. Additionally, noise adjustment component 212 can identify how changes or adjustments made to the modifications can change the effects of the quantum hardware noise. In one or more embodiments, if a new noise profile (e.g., the third noise profile) is observed on new or different quantum hardware, noise adjustment component 212 can also identify modifications (e.g., second modifications) that can be applied to the ideal circuit to ensure that the ideal circuit can match the original noise profile employed in QML modeling.

### Noise Model Learning and Optimization Via a Data-Driven Approach:

In one or more embodiments, quantum hardware noise leveraging model 110 can also employ a data-driven approach to learn or further refine noise model 128. According to the data-driven approach, given a dataset of interest (e.g., input dataset 122) and ansatz of interest (e.g., ansatz circuit 120), the results generated by executing ansatz circuit 120 based on input dataset 122 can be measured by optimization component 214 on a quantum hardware, wherein measuring the results can comprise measuring a set of observable measurements per encoded data point. That is, in one or more embodiments, optimization component 214 can measure a set of observable measurements on a quantum hardware, given ansatz circuit 120 and input dataset 122. Further, the results can be measured for a suitably small subset of input dataset 122, such that a subsequent optimization process to optimize noise model 128 can be run more efficiently. In one or more embodiments, upon measuring the results, an initial noise model can be selected by optimization component 214. The initial noise model can be noise model 128 (previously derived or learnt by noise learning component 204), or the initial noise model can be a random set of Pauli operators and their starting coefficients such as, for example, a set of sparse Pauli coefficients for each Pauli operator in noise model 128. This can generate the probability of a Pauli operator versus a no-op identity operation. A Pauli operator can transform a qubit by flipping its quantum state or changing a phase, whereas a no-op identity operation refers to a quantum operation that leaves the quantum state of a qubit unchanged.

In one or more embodiments, after selecting the initial noise model, the coefficients of the noise model can be optimized by optimization component 214. That is, optimization component 214 can optimize the quantum hardware noise learnt by noise learning component 204 by optimizing coefficients of noise model 128. In one or more embodiments, optimization component 214 can employ a black box optimization algorithm such as Simultaneous Perturbation Stochastic Approximation (SPSA) or coordinate descent to optimize the coefficients of noise model 128. For example, optimization component 214 can generate simulated observable measurements for noise model 128, wherein the simulated observable measurements can be generated with or without perturbed coefficients. For example, in an embodiment, optimization component 214 can generate simulated observable measurements for noise model 128 for all data points comprised in input dataset 122 (at this step and in subsequent optimization steps). In another embodiment, optimization component 214 can generate simulated observable measurements for noise model 128 with perturbed coefficients according to the black box optimization approach. For example, in case of the coordinate descent algorithm, the simulated observable measurements can comprise different small changes to a single parameter.

Upon generating the simulated observable measurements, optimization component 214 can calculate a difference between the set of observable measurements and the simulated observable measurements, wherein the difference can be measured for respective parameters, and wherein the parameters can be the parameters of noise model 128. For example, the parameters can be the probabilities for a set of Pauli operators, or circuit operations, at each position in the quantum circuit, for each layer of noise model 128. For example, initial noise model learning or independent selection can generate a set of one-qubit and two-qubit operations to include in noise model 128. At each different location in the quantum circuit, it can be desirable to include the one-qubit and two-qubit operations around each unique layer (e.g., a pattern of two-qubit gates) in the hardware-mapped circuit. For example, one such operation can be a two-qubit Pauli ZZ operation on qubits i and j inserted after the first set of two-qubit operations in the original quantum circuit, and its corresponding parameter can be the probability of applying the Pauli ZZ operation on that pair of qubits when running the quantum circuit (with no-operation i.e., identity operation done otherwise). The parameters can then correspond to each of the probabilities of each operation being applied (i.e., the random noise effects). Thus, the number of parameters can be equal to the number of unique operations in noise model 128. Then, for each different parameter, optimization component 214 can measure the difference in the values of the measurements of the simulated observables and the set of observables measured on the quantum hardware. The difference can be measured via any suitable metric such as a mean squared error (MSE) or another metric.

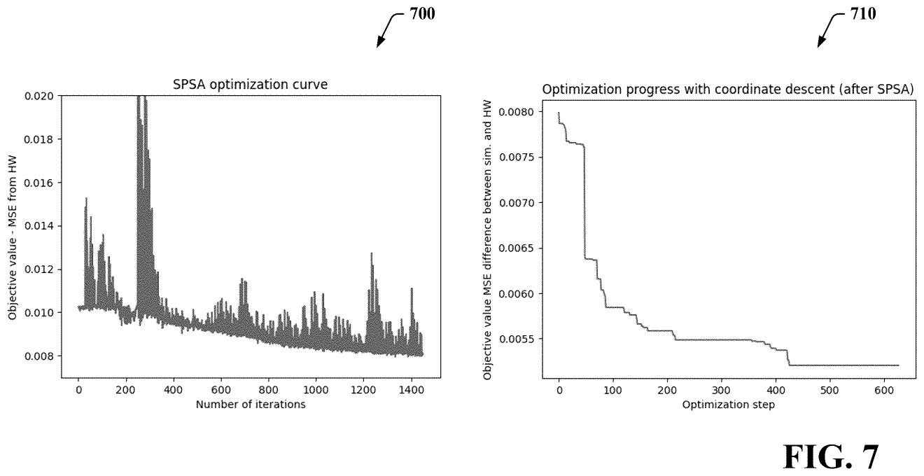

In one or more embodiments, optimization component 214 can update the coefficients of noise model 128 to reduce an error between the set of observable measurements and the simulated observable measurements until the error converges. For example, based on the results generated by executing ansatz circuit 120 based on input dataset 122 and the optimization approach described herein, wherein the optimization approach can involve evaluating the results of additional perturbed coefficients, optimization component 214 can make a decision to execute the step of updating the coefficients of noise model 128 to reduce the MSE (or another metric) between the set of observable measurements and the simulated observable measurements. In one or more embodiments, optimization component 214 can repeat the steps of generating the simulated observable measurements, measuring the difference between the set of observable measurements and the simulated observable measurements and reducing the error between the set of observable measurements and the simulated observable measurements until the error value converges. Thus, in one or more embodiments, reproducing the quantum hardware noise or generating quantum hardware noise that is very similar to the actual error of a quantum hardware can be an iterative process involving iterative optimization of noise model 128. Exemplary optimization results are illustrated in FIG. 7.

In one or more embodiments, the data-driven approach can be extended to cases where ansatz circuit 120 and noise model 128 cannot be tractably simulated such as, for example, if ansatz circuit 120 is large enough and therefore, difficult to efficiently simulate. This can be achieved via the following approaches.

Approach 1: In an embodiment, ansatz circuit 120 can be a large circuit that can be partitioned into a small set of smaller pieces/circuits. In some cases, the smaller circuits can even follow the same local pattern as ansatz circuit 120, such that each smaller circuit can be a repeated piece of the large circuit. This approach can target capturing the correct noise models for the smaller circuits, such that upon combining respective noise models of the respective smaller circuits and applying the combined noise models to the larger circuit, the noise effects associated with the quantum hardware can be captured appropriately.

More specifically, in an embodiment, data access component 202 can access ansatz circuit 120 and input dataset 122, and noise learning component 204 can learn, based on ansatz circuit 120 and input dataset 122, quantum hardware noise associated with a quantum hardware, without simulating ansatz circuit 120. To learn the quantum hardware noise, circuit partitioning component 216 can partition ansatz circuit 120 into a set of smaller circuits. Based on the set of smaller circuit, noise learning component 204 can learn respective noise models for respective smaller circuits comprised in the set of smaller circuits, and noise learning component 204 can combine the respective noise models to learn noise model 128 corresponding to ansatz circuit 120. By learning noise model 128, noise learning component 204 can learn the quantum hardware noise associated with the quantum hardware, and the quantum hardware noise can be employable in an adaptive QML process, as described in one or more embodiments.

Approach 2: In an embodiment, Approach 1 can be reversed and applied. For example, a model can be identified to eliminate the quantum hardware noise effects to capture and learn the noise model. For example, in an embodiment, data access component 202 can access ansatz circuit 120 and input dataset 122, and noise learning component 204 can learn, based on ansatz circuit 120 and input dataset 122, quantum hardware noise associated with a quantum hardware, without simulating ansatz circuit 120. To learn the quantum hardware noise, noise learning component 204 can identify a noise model that can eliminate hardware noise effects associated with a quantum hardware.

In this embodiment, the optimization of the noise model can be executed/performed/run over the set of observable measurements (i.e., the quantum hardware observed results) instead of the simulated observable measurements (i.e., the simulator observed results), and a set of inputs for which the noiseless outputs are known or a restricted set of inputs computed once up-front (even if costly) can be employed in the optimization process.

Approach 3: In this approach, a delta noise model can be learnt by comparing the results of heavier error mitigation with the results of no error mitigation, instead of comparing first noise profile 124 (generated by employing a simulator) and second noise profile 126 (generated by employing a quantum hardware). The delta noise model can then be modified as desired. For example, in an embodiment, data access component 202 can access ansatz circuit 120 and input dataset 122, and noise learning component 204 can learn, based on ansatz circuit 120 and input dataset 122, quantum hardware noise associated with a quantum hardware, without simulating ansatz circuit 120. To learn the quantum hardware noise, noise learning component 204 can learn a delta noise model by comparing first results of a first quantum computation and second results of a second quantum computation. The first quantum computation can comprise executing, by quantum circuit execution component 208, ansatz circuit 120 with error mitigation on a quantum hardware, whereas the second quantum computation can comprise executing, by quantum circuit execution component 208, ansatz circuit 120 without error mitigation on the quantum hardware.

Approach 4: In this approach, ansatz circuit 120 can be first approximated by a technique in which ansatz circuit 120 can be efficient to simulate, such as by Cliffordization, that is, by mapping ansatz circuit 120 to the hardware native gates and converting any non-Clifford operations to their nearest Clifford gate. For example, in some machines (i.e., quantum hardware) after mapping, the only non-Clifford operations remaining are rotations by non-multiples of π/2. Thus, one approach is to convert such angles to the nearest multiple. This does not preserve the same circuit outputs, but can preserve the same noise properties and be employable for optimizing noise model 128. In this case, ansatz circuit 120 can be efficiently simulated with specific techniques, and the noise model version of the modified quantum circuit can be simulated and compared with the hardware outputs for the same modified quantum circuit.

Additional embodiments of quantum hardware noise leveraging model 110 are described in greater detail with reference to the subsequent figures.

FIG. 2 illustrates another block diagram of an example, non-limiting system 200 that can learn quantum hardware noise and employ the quantum hardware noise in QML, in accordance with one or more embodiments described herein. Repetitive description of like elements and/or processes employed in respective embodiments is omitted for sake of brevity.

Non-limiting system 200 illustrates the system of quantum hardware noise leveraging model 110. As described with reference to FIG. 1, quantum hardware noise leveraging model 110 can comprise data access component 202, noise learning component 204, QML component 206, quantum circuit execution component 208, quantum circuit generation component 210, noise adjustment component 212, optimization component 214 and circuit partitioning component 216.

Existing quantum computing techniques typically aim to hide or remove quantum hardware noise from the quantum computer. On the contrary, embodiments of the present disclosure aim to understand and learn quantum hardware noise effects and beneficially employ the quantum hardware noise in QML modeling. For example, as described in one or more embodiments, quantum hardware noise leveraging model 110 can leverage the positive effects of quantum hardware noise in QML modeling by learning the quantum hardware noise and adjusting it. As a result, the quantum hardware noise can be employed as a source of control and the corresponding quantum hardware noise effects can be translated from one quantum hardware (e.g., quantum computer, quantum computing system/device, quantum machine, etc.) to another quantum hardware (e.g., quantum computer, quantum computing system/device, quantum machine, etc.). That is, quantum hardware noise leveraging model 110 can learn quantum hardware noise on one quantum hardware and reproduce the quantum hardware noise on another quantum hardware, which can be advantageous for machine learning models instead of being problematic. On the contrary, when building machine learning models, existing quantum computing techniques are constrained to employing the same quantum hardware because different quantum hardware can generate different noise profiles.

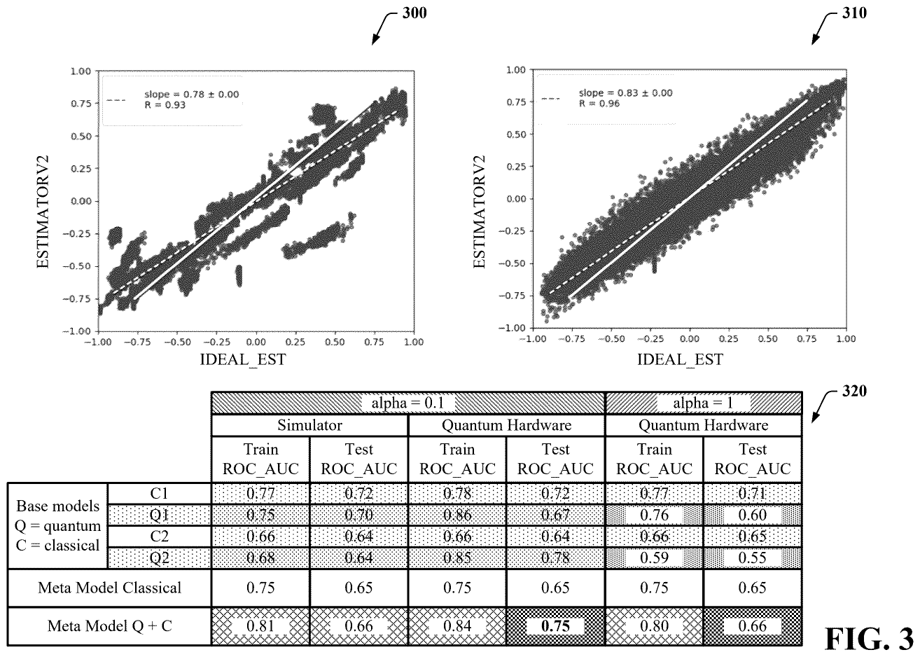

FIG. 3 illustrates diagrams of example, non-limiting graphs 300 and 310 showing quantum hardware noise effects and an example, non-limiting table 320 showing meta model results based on the quantum hardware noise effects, in accordance with one or more embodiments described herein. Repetitive description of like elements and/or processes employed in respective embodiments is omitted for sake of brevity.

It was experimentally observed that executing the QML approach discussed with reference to FIGS. 1 and 2 on quantum hardware (by employing a quantum feature map, followed by performing projected measurements, followed by classical machine learning modeling) resulted in unique quantum hardware noise effects that were much different than those resulting from simulations for certain ansatz configurations (i.e., smaller rotation scaling). This difference is illustrated by non-limiting graphs 300 and 310. The unique quantum hardware noise effects were observed to be beneficial for machine learning modeling. Specifically, the quantum hardware noise effects introduced diversity in an ensemble (i.e., a model combining QML models and classical machine learning models), wherein the diversity was experimentally leveraged to improve the accuracy of the ensemble. The results representative of the improved accuracy are illustrated in non-limiting table 320. It should be appreciated that for confidentiality reasons, the result values presented in non-limiting table 320 are obfuscated versions of the original values resulting from the real experiment. However, the respective result values presented in non-limiting table 320 have the same approximate relationships with one another as those of the original values resulting from the real experiment. Additionally, it was observed that the quantum hardware noise effects could not be easily reproduced without the quantum hardware. For example, the quantum hardware noise effects could not be easily reproduced by introducing simple classical noise models or other types of behaviors such as forcing overfitting in base models or changing model tuning. To consistently achieve the quantum hardware noise effects (e.g., with different quantum hardware configurations, different quantum hardware or drift in the quantum hardware), to have a greater degree of control over the quantum hardware noise, and to incorporate the quantum hardware noise in tuning machine learning models as part of a simulation, embodiments of the present disclosure can be employed to learn the quantum hardware noise and effectively incorporate the quantum hardware noise in QML modeling in an adaptive QML process.

In this regard, non-limiting graph 300 illustrates quantum hardware noise effects resulting from quantum measurements performed on a quantum hardware, and non-limiting graph 310 illustrates quantum hardware noise effects resulting from quantum measurements performed via a simulator (e.g., a classical simulator of a quantum computer). In both non-limiting graph 300 and non-limiting graph 310, the solid diagonal line represents the noise profile resulting from removing quantum hardware noise, that is, the results generated by the simulator. Additionally, the results in non-limiting graph 300 were generated with a rotation scaling of 0.1 and a first quantum hardware configuration, and the results in non-limiting graph 310 were generated with a rotation scaling of one (1) and a second quantum hardware configuration different than the first quantum hardware configuration. In quantum computing, rotation scaling is the scaling of rotation angles applied to qubits during quantum operations.

Evidently, the quantum hardware configuration employed to generate non-limiting graph 300 results in significantly different quantum hardware noise effects than those expected (i.e., non-limiting graph 310). That is because peculiarities in the behavior of a quantum computer resulting from quantum hardware noise can generate islands, such as those appearing in non-limiting graph 300. Such islands represent a consistent behavior of the quantum hardware and are related to the quantum hardware noise associated with the quantum hardware.

This behavior of the quantum hardware can assist machine learning models to analyze and identify data (e.g., in input dataset 122). For example, the quantum hardware noise effects illustrated in non-limiting graph 300 can assist machine learning models in data identification. However, this is not possible if larger rotation angles are employed to achieve results that can theoretically have reduced quantum hardware noise and quantum hardware noise effects. Instead, this can generate quantum hardware noise effects that are more or less distributed, or all over the place. On the contrary, performing experiments on a quantum hardware rather than a simulator can involve scaling with smaller rotation angles. Small rotation angles can generate quantum hardware noise effects that are consistent with the behavior of the quantum hardware and that can assist machine learning models. Accordingly, embodiments of the present disclosure can employ smaller rotation angles to learn quantum hardware noise and quantum hardware noise effects and generate a precise noise model (e.g., noise model 128) that can be employed to enhance machine learning models in a quantum hardware, a simulator, etc.

Non-limiting table 320 shows experimental results based on a complex model, that is, an ensemble comprising QML models and classical machine learning models (i.e., meta model results) for the first and second quantum hardware configurations employed to generate non-limiting graphs 300 and 310, respectively. As evident from non-limiting table 320, a noisy quantum hardware can generate better results than those generated by equivalent simulator runs for a QML process employing the ensemble. For the case of the unique quantum hardware noise effects (alpha=0.1) observed in non-limiting graph 300, unexpected benefits were observed. For example, a significant diversity in the ensemble was observed which lead to greater improvements from the ensemble. Thus, embodiments of the present disclosure provide a practical benefit for QML modeling by providing competitive but diverse/complementary QML modeling as compared to classical machine learning modeling.

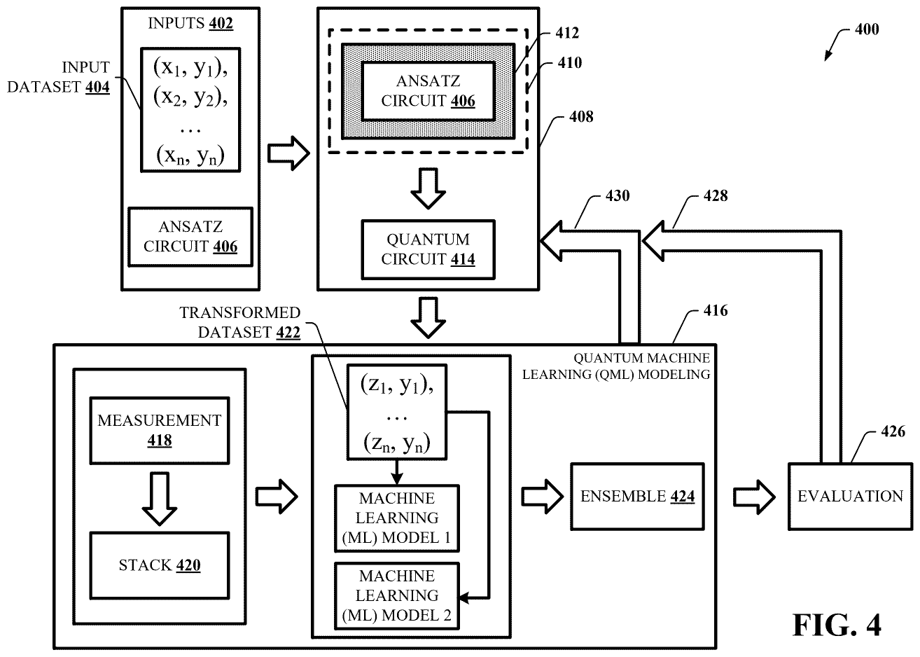

FIG. 4 illustrates a flow diagram of an example, non-limiting method 400 that can learn quantum hardware noise and employ the quantum hardware noise in QML, in accordance with one or more embodiments described herein. Repetitive description of like elements and/or processes employed in respective embodiments is omitted for sake of brevity.

Non-limiting method 400 illustrates the workflow that can be employed by quantum hardware noise leveraging model 110 to learn and leverage quantum hardware noise, as described with reference to FIGS. 1 and 2. Non-limiting method 400 illustrates a high-level solution to the challenges associated with quantum hardware noise, and represents an end-to-end QML approach (e.g., an adaptive QML process) that can be employed to identify and learn beneficial quantum hardware noise effects, incorporate the quantum hardware noise effects in QML modeling and make the quantum hardware noise effects controllable and reproducible. Making the quantum hardware noise effects controllable and reproducible can involve introducing the quantum hardware noise effects into different quantum circuits, quantum hardware and simulations, beneficially tuning the quantum hardware noise for machine learning processes and increasing or decreasing the quantum hardware noise effects or the size/amount of the corresponding quantum hardware noise.

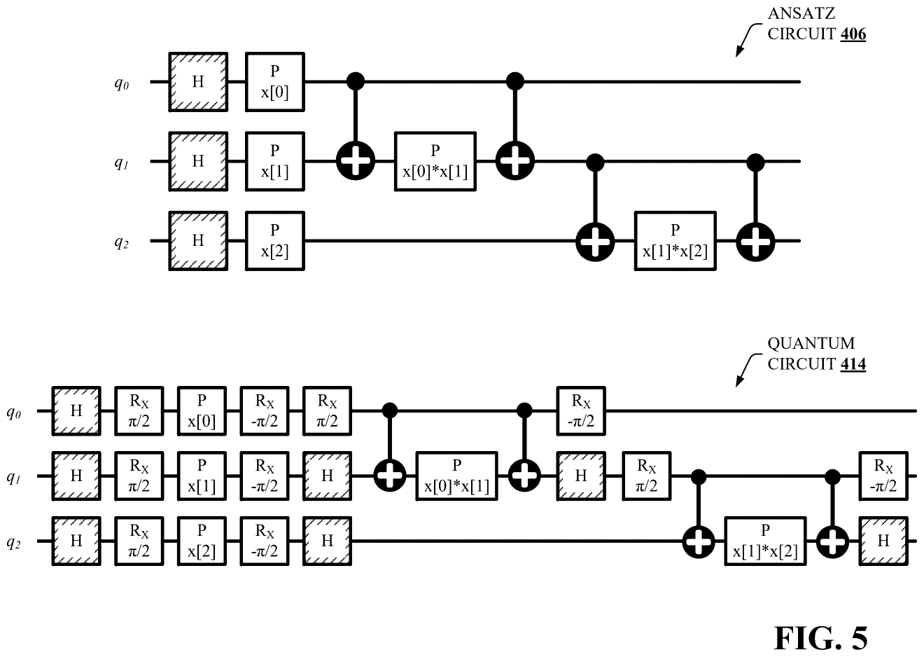

Accordingly, in non-limiting method 400, inputs 402 comprising input dataset 404 and ansatz circuit 406 can be accessed by data access component 202. Input dataset 404 can be an example of input dataset 122 and ansatz circuit 406 can be an example of ansatz circuit 120. For example, input dataset 404 can comprise data points (x₁, y₁), (x₂, y₂), . . . , (xₙ, yₙ), and ansatz circuit 406 can be an initial ansatz U(x) (illustrated in FIG. 5).

At 408 in non-limiting method 400, noise learning component 204 can learn (e.g., via noise-aware mapping) quantum hardware noise, based on input dataset 404 and ansatz circuit 406. It should be appreciated that the embodiments of the present disclosure are not independent of the input dataset similar to general machine learning, and employing noise learning component 204 for specific datasets can involve fine tuning. As described in one or more embodiments, learning quantum hardware noise can comprise learning a noise model (i.e., a quantum hardware noise model such as noise model 128) and identifying, based on the noise profile, first modifications that can be applied to ansatz circuit 406 to reproduce a noise profile (e.g., second noise profile 126) resulting from executing of ansatz circuit 406 on a quantum hardware. Accordingly, at 408 in non-limiting method 400, quantum circuit execution component 208 can execute ansatz circuit 406 on a quantum hardware to learn errors, that is, quantum hardware noise, associated with the quantum hardware and identify the first modifications. Thereafter, quantum circuit generation component 210 can apply the first modifications to ansatz circuit 406, wherein applying the first modifications can generate a new quantum circuit (also known as a blueprint or a blueprint circuit/blueprint quantum circuit) U′(x) (illustrated in FIG. 5) and learned Pauli error channels. In FIG. 4, the new quantum circuit is illustrated as quantum circuit 414. Additionally, at 408, block 410 represents the environment, and block 412 represent the quantum hardware.

In one or more embodiments, learning noise model 128 can comprise learning Pauli noise channels, which are a type of quantum error channels. Accordingly, in one or more embodiments, noise model 128 can be a Pauli noise channel and ansatz circuit 406 can be a quantum feature map circuit template. A Pauli noise channel can be described as taking the probability of certain Pauli operators to be applied as quantum errors. That is, a Pauli noise channel models quantum errors by applying Pauli operators with certain probabilities to qubits. Thus, in various embodiments, a quantum error (e.g., quantum hardware noise) can be modeled as a Pauli operator that can be applied to qubits with a certain probability, and the Pauli noise channel can simply be the sum of different Pauli operators applied with different probabilities to qubits. For example, the expectation value of a certain Pauli operator can be obtained with 1100 samples (i.e., by measuring the Pauli operators multiple times), and the corresponding Pauli noise channel can comprise only two terms—an identity term with a probability of 0.9 (i.e., a 90 percent (%) probability) and a Pauli operator term with a probability of 0.1. That is, the Pauli noise channel can be the sum of the expectation values of the Pauli operators over a perfect circuit without error, and temporal samples that correspond to the error circuit where the Pauli operator was applied. Additional embodiments related to learning a Pauli noise channel are described in the section titled Pauli noise channel learning.

At 416 in non-limiting method 400, QML component 206 can perform QML modeling. For example, in an embodiment, QML component 206 can employ quantum circuit 414 to generate transformed dataset 422 based on input dataset 404. For example, QML component 206 can generate a projected quantum feature map (PQFM) for quantum circuit 414. A quantum feature map is a technique employed in quantum computing to transform classical data into a high-dimensional quantum state that can be processed by a quantum computer. Based on the PQFM, QML component 206 can perform quantum feature map state measurements by executing quantum circuit 414. For example, QML component 206 can apply U′(x) to measure (illustrated by measurement 418) expectation values for observables X, Y and Z or shadows, and QML component 206 can stack (illustrated by stack 420) the expectation values to form new features for all data points x. Non-limiting method 600 illustrates the process of employing the outcomes of measurement 418 to generate stack 420. The new features thus generated can represent transformed dataset 422 comprising data points (z₁, y₁), (z₂, y₂), . . . , (zₙ, yₙ).

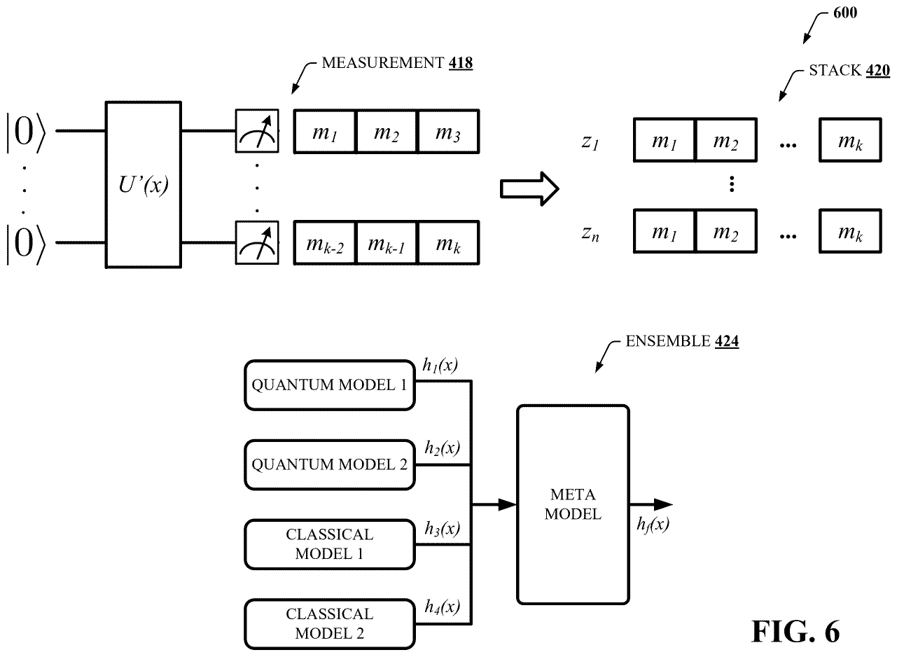

In one or more embodiments, QML component 206 can employ transformed dataset 422 in an adaptive QML process. Herein, employing transformed dataset 422 to apply machine learning can comprise training one or more QML models or one or more classical machine learning models. For example, QML component 206 can employ transformed dataset 422 to train machine learning model 1 (e.g., an XGBoost model), machine learning model 2 (e.g., an RF model), etc. to apply machine learning with the new features. In one or more embodiments, QML component 206 can also employ transformed dataset 422 in meta modeling. For example, QML component 206 can generate ensemble 424 (illustrated in FIG. 6) comprising a combination of one or more QML models and one or more classical machine learning models trained on transformed dataset 422, as described with reference to FIGS. 1-3.

At 426 in non-limiting method 400, noise adjustment component 212 can evaluate the predictions made by the machine learning models (i.e., QML models and/or classical machine learning models) employed in the QML modeling to determine whether the quantum hardware employed in the QML process has drifted or has been replaced with new quantum hardware. Noise adjustment component 212 can evaluate different metrics to evaluate the predictions. In response to a determination that the quantum hardware has drifted over time or a new quantum hardware is being employed, noise adjustment component 212 can adjust, at 428 in non-limiting method 400, the noise model to match the noise employed to train the machine learning models. For example, noise adjustment component 212 can add specific Paulis/Pauli operators at certain positions within ansatz circuit 406 such that quantum circuit 414 can reproduce the noise profile (e.g., second noise profile 126) resulting from executing of ansatz circuit 406 on a quantum hardware. Further, at 430 in non-limiting method 400, noise adjustment component 212 can recalibrate/iterate ansatz circuit 406, as desired, to tune/adjust ansatz circuit 406 to better match the quantum hardware noise effects and to adjust the quantum hardware noise effects as desired. For example, noise adjustment component 212 can increase the diversity in an ensemble employed in the QML modeling by tuning, amplifying or reducing the quantum hardware noise effects.

### Pauli Noise Channel Learning:

As discussed in one or more embodiments, noise model 128 can be a Pauli noise channel. That is, in various embodiments, noise learning component 204 can learn quantum hardware noise associated with a quantum hardware by learning a Pauli noise channel. In this regard, this section explains how a Pauli noise channel can be learnt by employing suitable probabilities (e.g., applying a quantum gate with a probability) and parameters to reproduce the effect of the quantum hardware noise on a new quantum hardware or in case of drift in the quantum hardware. In one or more embodiments, learning the Pauli noise channel can involve learning (e.g., by noise learning component 204) a true blueprint circuit (e.g., quantum circuit 414) by creating a noise model (e.g., Paul noise channels) that can capture the differences between a noiseless simulation (e.g., first noise profile 124) of ansatz circuit 406 and a noisy execution of ansatz circuit 406 on a quantum hardware. As discussed in one or more embodiments, this can correspond to modification of ansatz circuit 406 to reproduce the results (i.e., quantum hardware effects/second noise profile 126) generated by executing ansatz circuit 406 on the quantum hardware.

A high-level overview of the approach that can be employed in one or more embodiments to learn a Pauli noise channel can be described as follows. In one or more embodiments, the noise learning process employed by noise learning component 204 can follow Van Den Berg et al. (cited in paragraph [0058]) wherein a sparse Pauli-Lindblad model (or sparse Pauli-Lindblad noise model) can be assumed. In the sparse Pauli-Lindblad model, the generators of a noise channel can comprise one-weight and two-weight Pauli operators, and the number of the total coefficients for the Pauli error rates for each two-qubit gate layer can be O(n), wherein n represents the number of qubits.

### Sparse Pauli-Lindblad Noise Model:

A model of a given n-qubit noise channel Λ that arises from a Sparse set of local interactions by a Lindblad generator can be given by Equation 1, wherein λₖ denotes the model coefficient corresponding to the Pauli matrix Pₖ, and κ is chosen as a poly(n) sized subset of all 4″ Pauli matrices.

$$ℒ ( p ) = {\sum }_{k ∈ κ} {λ}_{k} ( {P}_{k} ρ {P}_{k} - ρ ) \qquad Equation 1$$

Here, a sparse Pauli-Lindblad model (Van Den Berg et al. cited in paragraph) can be followed in which only a subset of one-weight and two-weight Pauli matrices are chosen for the generators. Considering the connectivity of qubits, the size of κ scales as [symbol] (n). The resulting noise model Λ(ρ)=exp[ [symbol] ](ρ) can be given by Equation 2, wherein m=|κ| and Λₖ(ρ) can be given by Equation 3.

$$Λ ( ρ ) = {Λ}_{1} ∘ {Λ}_{2} ∘ … ∘ {Λ}_{m} ( ρ ) = {○}_{k ∈ κ} {Λ}_{k} ( ρ ) \qquad Equation 2$$

$${Λ}_{k} ( ρ ) = {e}^{- {λ}_{k}} ( \frac{{e}^{{λ}_{k}} + {e}^{- {λ}_{k}}}{2} ρ + \frac{{e}^{{λ}_{k}} - {e}^{- {λ}_{k}}}{2} {P}_{k} ρ {P}_{k}^{†} ) = ( {w}_{k} ρ + ( 1 - {w}_{k} ) {P}_{k} ρ {P}_{k}^{†} ) , \\ where \\ {w}_{k} = ( 1 + {e}^{- 2 {λ}_{k}} ) / 2. \qquad Equation 3$$

### Noise Model Learning:

In one or more embodiments, the noise learning process can determine the model coefficients λₖ based on a set of measurable quantities. Here, the experiments of Van Den Berg et al. (cited in paragraph [0058]) can be followed, wherein the relationship between λₖ and the diagonal elements of a Pauli transfer matrix (PTM) fₐ is explicitly derived as given by Equation 4.

$${f}_{a} = \frac{1}{{2}^{n}} tr ( {P}_{k}^{†} Λ ( {P}_{a} ) ) = exp ( - 2 {\sum }_{k ∈ κ} {λ}_{k} {〈 a , k 〉}_{sp} ) , \\ where \\ {〈 a , k 〉}_{sp} = 0 if Paulis {P}_{a} and {P}_{b} commute , and {〈 a , k 〉}_{sp} = 1 otherwise . \qquad Equation 4$$

In one or more embodiments, learning the diagonal elements of a PTM, or the fidelities of Pauli channels, can be performed (e.g., by noise learning component 204) by repeating the same noise process up to d times, and the corresponding Pauli expectation values can be measured (e.g., by noise learning component 204) at every depth. The fidelities for the noise channel can then be extracted from the decay rates in the resulting curves (Van Den Berg et al. cited in paragraph [0058]).

A high-level overview of the approach that can be employed in one or more embodiments to manipulate the Pauli noise channel can be described as follows. Let wₖ be a probability distribution of Pauli errors of a true blueprint noise channel (also known as true blueprint error channel), and let

$${w}_{k}^{′}$$

be probability distributions of Pauli errors on the quantum hardware on which the true blueprint noise channel is to be reproduced. Then, with approaches similar to probabilistic error cancellation (PEC) described in Van Den Berg et al. (cited in paragraph [0058]) or to probabilistic error amplification (PEA) described in Kim, Youngseok, et al. (Kim, Youngseok, et al. “Evidence for the utility of quantum computing before fault tolerance.” Nature 618.7965 (2023): 500-505.), the true blueprint noise channel can be reproduced.

More specifically, let {λₖ} be the set of coefficients of the noise channel and {fₐ} be the fidelity that the various embodiments herein aim to realize. Further, let

$$\{ {λ}_{k}^{′} \}$$

be the set of coefficients of the noise channel on the real device on which the algorithm (i.e., quantum hardware noise leveraging model 110) is to be executed, and let

$${μ}_{k} = {λ}_{k} - {λ}_{k}^{′} .$$

Then, for all a, fₐ can be given by Equation 5.

$${f}_{a} = exp ( - 2 {\sum }_{k ∈ κ} {λ}_{k} {〈 a , k 〉}_{sp} ) = exp ( - 2 {\sum }_{k ∈ κ} ( {λ}_{k}^{′} + {μ}_{k} ) {〈 a , k 〉}_{sp} ) \qquad Equation 5$$

Therefore, with an additional noise channel \tilde{Λ}=◯_{k∈κ}\tilde{Λ}ₖ, where \tilde{Λ}ₖ(ρ) can be given by Equation 6, fₐ can be reproduced for all a.

$${\tilde{Λ}}_{k} ( ρ ) = {e}^{- {λ}_{k}} ( \frac{{e}^{{μ}_{k}} + {e}^{- {μ}_{k}}}{2} ρ + \frac{{e}^{{μ}_{k}} - {e}^{- {μ}_{k}}}{2} {P}_{k} ρ {P}_{k}^{†} ) \qquad Equation 6$$

Here, if μₖ≥0, it can be realized by probabilistic amplification of noise (Kim, Youngseok, et al. cited in paragraph [00128]), whereas if μₖ<0, it can be realized by probabilistic cancellation of noise (Van Den Berg et al. cited in paragraph [0058]).

It should be appreciated that the noise model described in one or more embodiments is learnt rather than created from scratch. Additionally, the noise model can be a complex model with a large number of coefficients that can be learnt from real quantum hardware noise by learning the coefficients of these expressions from the results of quantum operations performed on quantum hardware. Thus, in various embodiments, learning quantum hardware noise can involve real (physical) quantum hardware.

In summary, embodiments of the present disclosure can employ quantum hardware noise as a potential resource in a variety of ways. For example, quantum hardware noise can change quantum feature transformations. By changing/manipulating an ansatz circuit to change the impact or effects of the quantum hardware noise, the quantum feature map can be tuned to find a quantum feature map that can be more suitable for a given input dataset. Existing quantum computing techniques do not explore or leverage this degree of freedom to expand a set of unique quantum feature maps. Additionally, in various embodiments described herein, while the QML modeling can adapt to a particular quantum hardware noise to achieve a competitive performance, the quantum hardware noise can also be uniquely leveraged to create diversity in a QML model, such that the QML model can be useful when combined with other models via meta modeling. Existing quantum computing techniques also do not employ techniques to leverage quantum hardware noise in meta modeling. Finally, a noisy hardware version can correspond to some quantum open system and a more complex corresponding quantum feature map than the noiseless case, which can lead to increasing the difficulty of classically simulating a quantum circuit because the corresponding noise model can add significant complexity and depth to the simulation, thereby making the simulation difficult and lengthy. Thus, the various embodiments described herein can also present methods and techniques to generate QML models that can be effective despite being difficult to simulate.

Contrary to embodiments of the present disclosure, existing techniques also do not address the issue of applying a QML pipeline in production systems, that is, including QML in scenarios where pre-trained models can be applied over time as new data comes in and new decisions need to be made without having to continuously retrain the model, which can be a costly process. Applying QML in productions systems can be very valuable for practical applications of machine learning in different industries, for example, to make weekly demand forecasts, etc. However, a significant potential issue with QML pipelines is quantum hardware drift, which refers to the phenomena where the characteristics of quantum hardware noise on a quantum hardware can change over time. Quantum hardware drift can affect QML approaches and change the outputs of machine learning models over time. Another issue is that machines and quantum hardware can be upgraded over time, and new error mitigation and noise reduction techniques can be introduced. QML pipelines should account for such factors because these factors can also change the outputs of machine learning models. Finally, it can also be desirable to run a quantum circuit on different quantum hardware backends depending on, for example, the availability or cost effectiveness of quantum hardware, or to split/distribute a computational load among multiple quantum hardware. Embodiments of the present disclosure can provide a solution to the challenges resulting from quantum hardware drift, upgrades to quantum hardware, new quantum computing techniques and distributing computational load by learning quantum hardware noise and adjusting portions of a QML pipeline to match an underlying quantum system in different scenarios.

With continued reference to FIG. 4, FIG. 5 illustrates diagrams of example, non-limiting quantum circuits (ansatz circuit 406 and quantum circuit 414) that can be generated and utilized as part of non-limiting method 400, and FIG. 6 illustrates diagrams of an example, non-limiting method 600 and an example, non-limiting ensemble (ensemble 424) that can be employed as part of non-limiting method 400, in accordance with one or more embodiments described herein. Repetitive description of like elements and/or processes employed in respective embodiments is omitted for sake of brevity.

FIGS. 7-10 illustrate experimental results based on the embodiments of the present disclosure.

FIG. 7 illustrates diagrams of example, non-limiting graphs 700 and 710 showing results of optimizing noise model coefficients, in accordance with one or more embodiments described herein. Repetitive description of like elements and/or processes employed in respective embodiments is omitted for sake of brevity.

With reference to FIG. 1, recall that in one or more embodiments, optimization component 214 can optimize a noise model (e.g., noise model 128) by optimizing the coefficients of the noise model. In this regard, FIG. 7 illustrates exemplary optimization results generated by quantum hardware noise leveraging model 110 by optimizing the coefficients of a noise model based on a 6-qubit Heisenberg ansatz circuit (e.g., ansatz circuit 120).

To generate non-limiting graphs 700 and 710, a learning process with iterations was employed, wherein a classical optimizer was employed to adjust the parameters of the noise model. For example, starting with initial noise model coefficients, optimization component 214 of quantum hardware noise leveraging model 110 computed the MSE based on simulated observable measurements generated by simulating the ansatz circuit and a set of observable measurements generated by executing the ansatz circuit on the quantum hardware. That is, optimization component 214 calculated a difference between the simulated observable measurements and the set of observable measurements. The MSE values were averaged over 5 runs/iterations, and the optimizer (i.e., optimization algorithm) was treated as a black box by employing different optimizers. The optimizers that worked effectively included SPSA and coordinate descent. Non-limiting graph 700 illustrates the SPSA optimization curve based on the MSE values associated with the set of observable measurements generated via the quantum hardware, and non-limiting graph 710 illustrates the optimization curve based on the coordinate descent algorithm based on the MSE values associated with the difference between the simulated observable measurements and the set of observable measurements.

Non-limiting graphs 700 and 710 show that the optimization process is being learnt by optimization component 214. As evident from both non-limiting graphs 700 and 710, the learning curves of optimization component 214 slope downward with increasing number of iterations and optimization steps, and as the number of optimization steps increases, the noise model gets closer to the behavior of the quantum hardware.

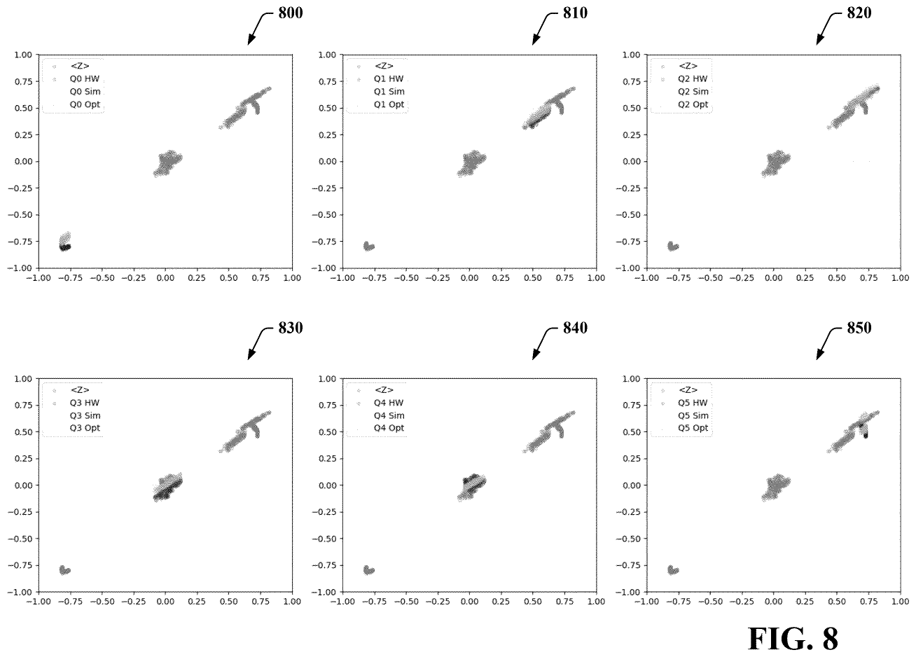

FIGS. 8-10 illustrates diagrams of example, non-limiting graphs 800-850, 900-950 and 1000-1050 showing quantum hardware noise effects for different qubits and different quantum operators, in accordance with one or more embodiments described herein. Repetitive description of like elements and/or processes employed in respective embodiments is omitted for sake of brevity.

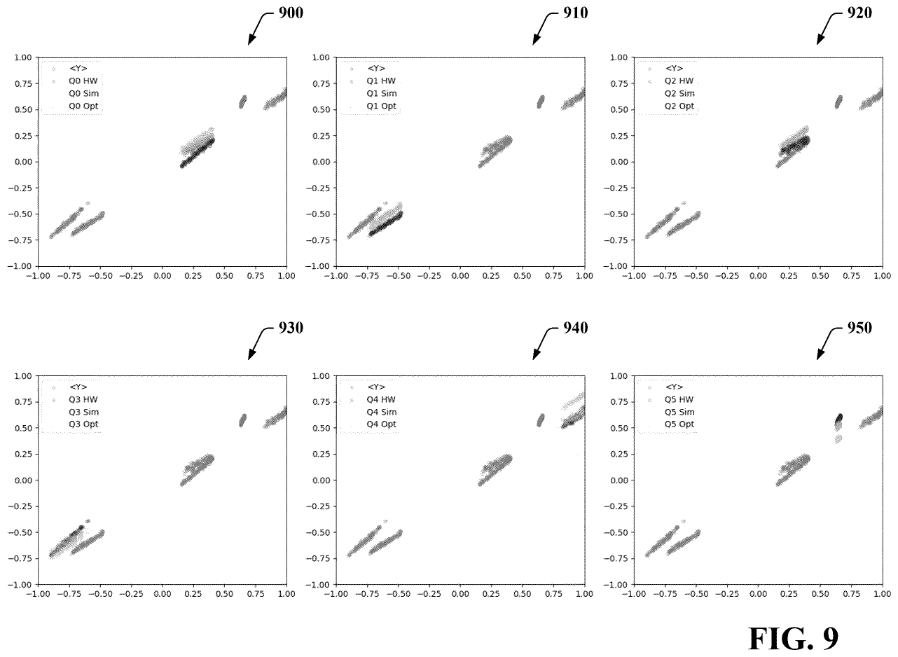

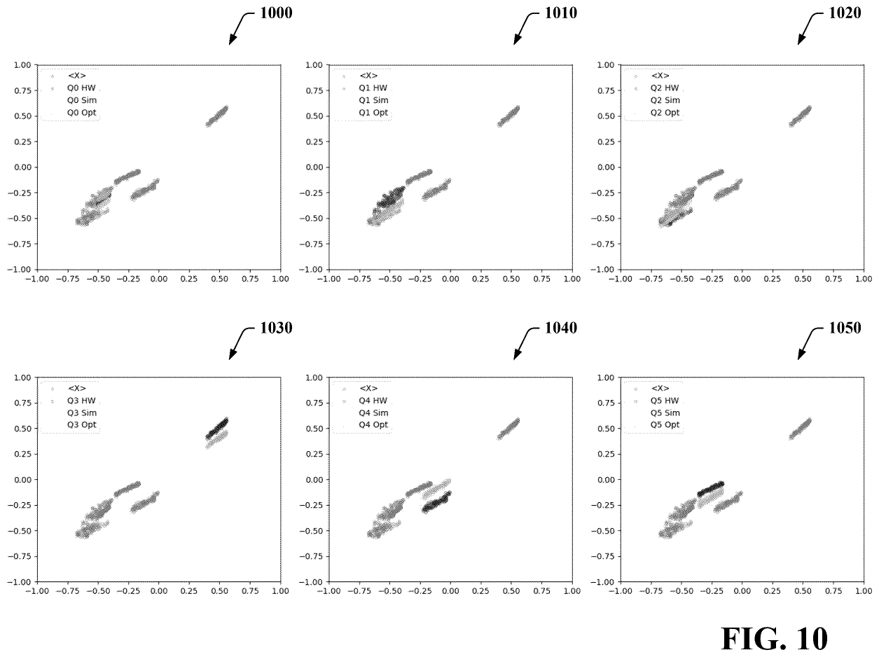

FIGS. 8-10 illustrate detailed representations of quantum hardware noise effects, similar to non-limiting graph 300 of FIG. 3. Non-limiting graphs 800, 810, 820, 830, 840 and 850 of FIG. 8, non-limiting graphs 900, 910, 920, 930, 940 and 950 of FIG. 9, and non-limiting graphs 1000, 1010, 1020, 1030, 1040 and 1050 of FIG. 10 illustrate respective quantum hardware noise effects (observable results and differences) for different respective qubits and quantum operators in a quantum circuit. That is, each of the illustrated graphs in FIGS. 8-10 corresponds to a different qubit in a quantum circuit. For example, each of non-limiting graphs 800-850 illustrates the quantum hardware noise effects per qubit for the Z operator to show the quantum hardware noise effects in the Z direction of the quantum operations. Similarly, each of non-limiting graphs 900-950 illustrate the quantum hardware noise effects per qubit for the Y operator to show the quantum hardware noise effects in the Y direction of the quantum operations. Finally, each of non-limiting graphs 1000-1050 illustrate the quantum hardware noise effects per qubit for the X operator to show the quantum hardware noise effects in the X direction of the quantum operations.

In each graph, the red data points represent the quantum hardware noise effects generated by performing quantum measurements on a quantum hardware (e.g., by executing the quantum circuit on the quantum hardware), the yellow data points represent the quantum hardware noise effects generated by executing the quantum circuit on a simulator with noise in the simulator, and the blue data points represent the quantum hardware noise effects generated with the optimized version of the simulated noise. For example, in non-limiting graph 800, the yellow data points are higher than the red data points along the Y-axis, and the blue data points generated after optimization are closer to the red data points, which illustrates the advantages of optimizing the noise model. To generate the graphs of FIGS. 8-10, noise learning component 204 was employed to learn the noise model. Thereafter, the yellow data points were generated based on the coefficients of the noise model. Finally, the noise model was optimized to generate the blue data points that are similar to the red data points. Stated differently, the coefficients of the noise model were learnt and optimized to fine tune the coefficients and generate a more precise noise model that can represent quantum hardware effects similar to those inherent within the quantum hardware.

It can be observed from FIGS. 8-10 how a noise model can be learnt and employed to reproduce islands similar to those illustrated in non-limiting graph 300, and the methods and techniques employed herein can approximate the real behavior of a quantum hardware, even when the quantum hardware noise that is learnt may not be exactly identical to the quantum hardware noise generated by the quantum hardware.

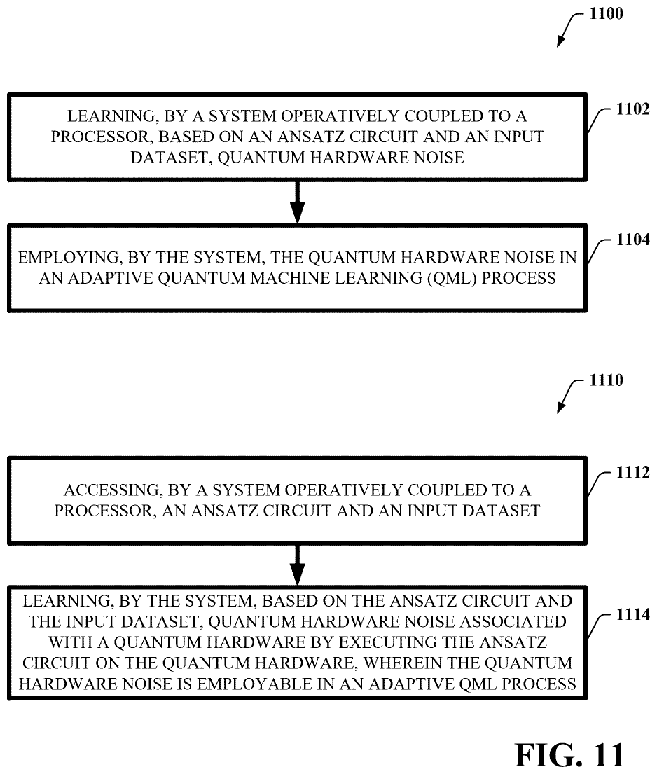

FIG. 11 illustrates flow diagrams of example, non-limiting methods 1100 and 1110 that can learn quantum hardware noise and employ the quantum hardware noise in QML, in accordance with one or more embodiments described herein. Repetitive description of like elements and/or processes employed in respective embodiments is omitted for sake of brevity.

At 1102, non-limiting method 1100 can comprise learning (e.g., by noise learning component 204), by a system operatively coupled to a processor, based on an ansatz circuit and an input dataset, quantum hardware noise.

At 1104, non-limiting method 1100 can comprise employing (e.g., by QML component 206), by the system, the quantum hardware noise in an adaptive QML process.

In non-limiting method 1100, learning the quantum hardware noise can comprise simulating the ansatz circuit on a simulator (e.g., a classical simulator of a quantum computer). However, in some scenarios, an ansatz circuit can be significantly large and cannot be simulated. In such scenarios, non-limiting method 1110 can be employed to learn the quantum hardware noise.

At 1112, non-limiting method 1110 can comprise accessing (e.g., by data access component 202), by a system operatively coupled to a processor, an ansatz circuit and an input dataset.

At 1114, non-limiting method 1110 can comprise learning (e.g., by noise learning component 204), by the system, based on the ansatz circuit and the input dataset, quantum hardware noise associated with a quantum hardware by executing the ansatz circuit on the quantum hardware, wherein the quantum hardware noise is employable in an adaptive QML process.

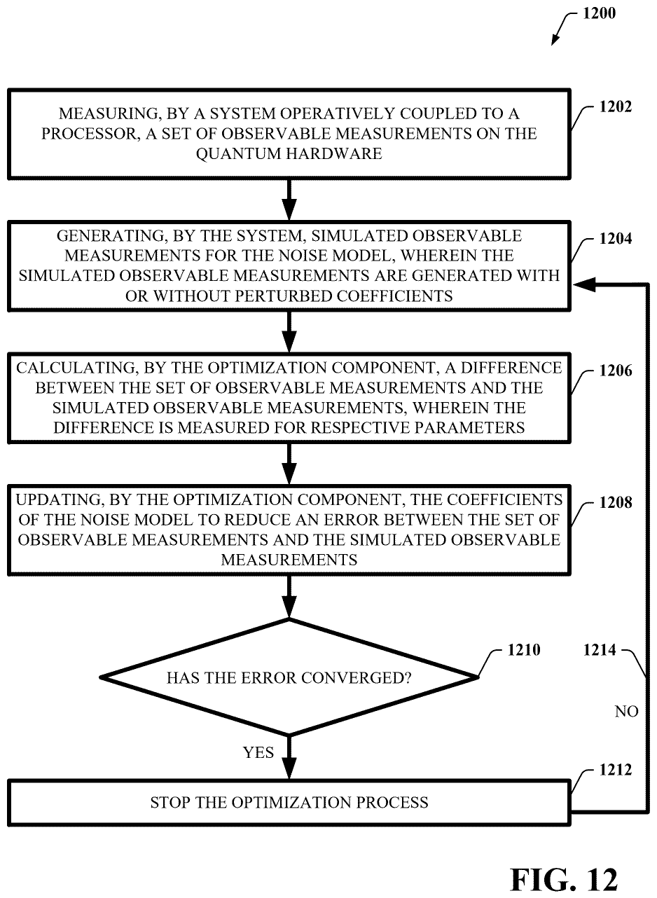

FIG. 12 illustrates a flow diagram of an example, non-limiting method 1200 that can optimize a noise model representative of quantum hardware noise, in accordance with one or more embodiments described herein. Repetitive description of like elements and/or processes employed in respective embodiments is omitted for sake of brevity.

With continued reference to non-limiting method 1100, in one or more embodiments, non-limiting method 1200 can be employed to optimize the noise model learnt by noise learning component 204.

At 1202, non-limiting method 1200 can comprise measuring (e.g., by optimization component 214), by a system operatively coupled to a processor, a set of observable measurements on the quantum hardware.

At 1204, non-limiting method 1200 can comprise generating (e.g., by optimization component 214), by the system, simulated observable measurements for the noise model, wherein the simulated observable measurements are generated with or without perturbed coefficients.

At 1206, non-limiting method 1200 can comprise calculating (e.g., by optimization component 214), by the system, a difference between the set of observable measurements and the simulated observable measurements, wherein the difference is measured for respective parameters.

At 1208, non-limiting method 1200 can comprise updating (e.g., by optimization component 214), by the system, the coefficients of the noise model to reduce an error between the set of observable measurements and the simulated observable measurements.

At 1210, non-limiting method 1200 can comprise determining (e.g., by optimization component 214), by the system, whether the error has converged. If yes, then at 1212, non-limiting method 1200 can comprise stopping (e.g., by optimization component 214), by the system, the optimization process. If not, then at 1214 non-limiting method 1200 can return to generating the simulated observable measurements at 1204.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 13 illustrates a block diagram of an example, non-limiting, operating environment 1300 in which one or more embodiments described herein can be facilitated. FIG. 13 and the following discussion are intended to provide a general description of a suitable operating environment 1300 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as quantum hardware noise leveraging code 1328. In addition to block 1328, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1328, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer-readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1328 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1328 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer-readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

CLOUD COMPUTING SERVICES AND/OR MICROSERVICES (not separately shown in FIG. 13): private and public clouds 1306 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a noise learning component that learns, based on an ansatz circuit and an input dataset, quantum hardware noise; and
a quantum machine learning (QML) component that employs the quantum hardware noise in an adaptive QML process.

2. The system of claim 1, wherein learning the quantum hardware noise comprises:
executing, by a quantum circuit execution component, the ansatz circuit via a noiseless simulation, wherein the executing the ansatz circuit via the noiseless simulation generates a first noise profile; and
executing, by the quantum circuit execution component, the ansatz circuit on a quantum hardware, wherein the executing the ansatz circuit on the quantum hardware generates a second noise profile.

3. The system of claim 2, wherein the learning the quantum hardware noise further comprises:
learning, by the noise learning component, a noise model that captures differences between the first noise profile and the second noise profile; and
identifying, by the noise learning component, based on the noise model, first modifications applicable to the ansatz circuit to reproduce the second noise profile.

4. The system of claim 3, further comprising:
a quantum circuit generation component that applies the first modifications to the ansatz circuit, wherein applying the first modifications generates a quantum circuit that is employable to transform the input dataset into a transformed dataset.

5. The system of claim 4, wherein the QML component employs the transformed dataset in the adaptive QML process, and wherein the adaptive QML process is based on a QML model or an ensemble comprising QML models and classical machine learning models.

6. The system of claim 3, further comprising:
a noise adjustment component that adjusts the second noise profile by adjusting the first modifications according to the adaptive QML process.

7. The system of claim 6, wherein the noise adjustment component further adjusts a third noise profile resulting from drift in the quantum hardware or execution of the ansatz circuit on a new quantum hardware, wherein the adjusting the third noise profile comprises adjusting second modifications applicable to the ansatz circuit to reproduce the third noise profile.

8. The system of claim 3, further comprising:
an optimization component that optimizes the quantum hardware noise by optimizing coefficients of the noise model, wherein the optimizing the coefficients comprises:
measuring, by the optimization component, a set of observable measurements on the quantum hardware;
generating, by the optimization component, simulated observable measurements for the noise model, wherein the simulated observable measurements are generated with or without perturbed coefficients;
calculating, by the optimization component, a difference between the set of observable measurements and the simulated observable measurements, wherein the difference is measured for respective parameters;
updating, by the optimization component, the coefficients of the noise model to reduce an error between the set of observable measurements and the simulated observable measurements until the error converges.

9. A computer-implemented method, comprising:
learning, by a system operatively coupled to a processor, based on an ansatz circuit and an input dataset, quantum hardware noise; and
employing, by the system, the quantum hardware noise in an adaptive QML process.

10. The computer-implemented method of claim 9, wherein the learning comprises:
executing, by the system, the ansatz circuit via a noiseless simulation, wherein the executing the ansatz circuit via the noiseless simulation generates a first noise profile; and
executing, by the system, the ansatz circuit on a quantum hardware, wherein the executing the ansatz circuit on the quantum hardware generates a second noise profile.

11. The computer-implemented method of claim 10, wherein the learning further comprises:
learning, by the system, a noise model that captures differences between the first noise profile and the second noise profile; and
identifying, by the system, based on the noise model, first modifications applicable to the ansatz circuit to reproduce the second noise profile.

12. The computer-implemented method of claim 11, further comprising:
applying, by the system, the first modifications to the ansatz circuit, wherein the applying the first modifications generates a quantum circuit that is employable to transform the input dataset into a transformed dataset.

13. The computer-implemented method of claim 12, further comprising:
employing, by the system, the transformed dataset in the adaptive QML process, wherein the adaptive QML process is based on a QML model or an ensemble comprising QML models and classical machine learning models.

14. The computer-implemented method of claim 11, further comprising:
adjusting, by the system, the second noise profile by adjusting the first modifications according to the adaptive QML process.

15. A computer program product for learning and leveraging quantum hardware noise in QML, the computer program product comprising a computer readable storage medium having program instructions embodied therewith, the program instructions executable by a processor to cause the processor to:
learn, by the processor, based on an ansatz circuit and an input dataset, quantum hardware noise; and
employ, by the processor, the quantum hardware noise in an adaptive QML process.

16. The computer program product of claim 15, wherein the program instructions are further executable by the processor to cause the processor to:
learn, by the processor, the ansatz circuit via a noiseless simulation, wherein the executing the ansatz circuit via the noiseless simulation generates a first noise profile; and
learn, by the processor, the ansatz circuit on a quantum hardware, wherein the executing the ansatz circuit on the quantum hardware generates a second noise profile.

17. The computer program product of claim 16, wherein the program instructions are further executable by the processor to cause the processor to:
learn, by the processor, a noise model that captures differences between the first noise profile and the second noise profile; and
identify, by the processor, based on the noise model, first modifications applicable to the ansatz circuit to reproduce the second noise profile.

18. The computer program product of claim 17, wherein the program instructions are further executable by the processor to cause the processor to:
apply, by the processor, the first modifications to the ansatz circuit, wherein the applying the first modifications generates a quantum circuit that is employable to transform the input dataset into a transformed dataset.

19. The computer program product of claim 18, wherein the program instructions are further executable by the processor to cause the processor to:
employ, by the processor, the transformed dataset in the adaptive QML process, wherein the adaptive QML process is based on a QML model or an ensemble comprising QML models and classical machine learning models.

20. A system, comprising:
a memory that stores computer executable components; and
a processor that executes the computer executable components stored in the memory, wherein the computer executable components comprise:
a data access component that accesses an ansatz circuit and an input dataset; and
a noise learning component that learns, based on the ansatz circuit and the input dataset, quantum hardware noise associated with a quantum hardware by executing the ansatz circuit on the quantum hardware, wherein the quantum hardware noise is employable in an adaptive QML process.

21. The system of claim 20, wherein learning the quantum hardware noise comprises:
partitioning, by a circuit partitioning component, the ansatz circuit into a set of smaller circuits.

22. The system of claim 21, wherein the learning the quantum hardware noise further comprises:
learning, by the noise learning component, respective noise models for respective smaller circuits comprised in the set of smaller circuits; and
combining, by the noise learning component, the respective noise models to learn a noise model corresponding to the ansatz circuit.

23. A computer-implemented method, comprising:
accessing, by a system operatively coupled to a processor, an ansatz circuit and an input dataset; and
learning, by the system, based on the ansatz circuit and the input dataset, quantum hardware noise associated with a quantum hardware by executing the ansatz circuit on the quantum hardware, wherein the quantum hardware noise is employable in an adaptive QML process.

24. The computer-implemented method of claim 23, wherein the learning comprises:
identifying, by the system, a noise model that eliminates hardware noise effects associated with the quantum hardware.

25. The computer-implemented method of claim 23, wherein the learning comprises:
learning, by the system, a delta noise model by comparing first results of a first quantum computation and second results of a second quantum computation, wherein the first quantum computation involves error mitigation, and wherein the second quantum computation is performed without the error mitigation.
